(19) United States
(12) Patent Application Publication
(10) Pub. No.: US 2002/0067446 A1
(43) Pub. Date: Jun. 6, 2002

(54) Optically efficient liquid crystal display device

(76) Inventor: Yu Wang, La Crescenta, CA (US)

Correspondence Address: FISH & RICHARDSON, PC, 4350 LA JOLLA VILLAGE DRIVE, SUITE 500, SAN DIEGO, CA, 92122, US

(21) Appl. No.: 09/730,500

(22) Filed: Dec. 4, 2000

Related U.S. Application Data
(60) Provisional application No. 60/168,963, filed on Dec. 3, 1999.

(51) Int. Cl. G02F 1/1335

(52) U.S. Cl. 349/113

(57) ABSTRACT

Optically efficient liquid crystal display devices that implement an optically reflective coating in an opaque area on a LCD panel and another optical reflector to redirect the light incident to the opaque area to transmit through the liquid crystal layer.

This application claims the benefit of U.S. Provisional Application No. 60/168,963, filed Dec. 3, 1999.

### ORIGIN OF THE INVENTION

The invention described herein was made in the performance of work under a NASA contract, and is subject to the provisions of Public Law 96-517 (35 USC 202) in which the Contractor has elected to retain title.

### TECHNICAL FIELD

This application relates to liquid crystal display devices, and more specifically, to techniques and display systems for efficiently coupling illumination light to liquid crystal display panels.

### BACKGROUND

Liquid crystal display (“LCD”) devices use a suitable liquid crystal material to modulate the intensity of light that transmits through a layer of the liquid crystal material placed between two polarizers. A control voltage is used to control the molecular orientation of the liquid crystal material so as to rotate the polarization of the input light. The transmitted light intensity, hence, can be varied by a change in the degree of the polarization rotation in the liquid crystal layer.

A LCD panel may be formed by placing the liquid crystal material between two transparent substrates. This LCD panel may be divided into a one-dimensional or two-dimensional array of LCD pixels. Each LCD pixel may include a pixel transistor, such as thin-film transistor (“TFT”), formed on one of the substrates to apply pixel a control voltage to the LCD pixel. Images can be formed on the LCD panel by using the pixel transistors to individually control the LCD pixels which in turn modulate light beams transmit through the pixels.

The transistor located in each LCD pixel, however, is usually not optically transparent. Hence, light incident to the transistor is not utilized to form the final image in many conventional LCD panels. This effectively reduces the aperture ratio of each LCD pixel. In addition, electrode busses that connect the pixel transistors to a panel control circuit and a power supply may also be optically opaque and hence can further reduce the actual transparent area in the LCD panel. In some commercial LCD panels, for example, the actual aperture ratio may be as low as 60% due to the presence of opaque pixel transistors and electrode busses. That is, about 40% of the input illumination light is not used for imaging formation and hence is wasted.

### SUMMARY

The present disclosure includes techniques and systems that implement an optically reflective coating in an opaque area on a LCD panel and another optical reflector to redirect the light incident to the opaque area to transmit through the liquid crystal layer. Such light, which would otherwise be wasted, thus can be used for image formation in the LCD panel. The optical efficiency of using the input illumination light, therefore, can be significantly enhanced.

### BRIEF DESCRIPTION OF THE DRAWINGS

FIG. 1 illustrates an example of a LCD pixel in a LCD panel.

FIGS. 2A and 2B show two exemplary LCD devices according to one embodiment.

FIG. 2C shows one example of a patterned reflective layer for the LCD panel shown in FIG. 1.

FIG. 3 illustrates recycling reflected light in the LCD device shown in FIG. 2A.

### DETAILED DESCRIPTION

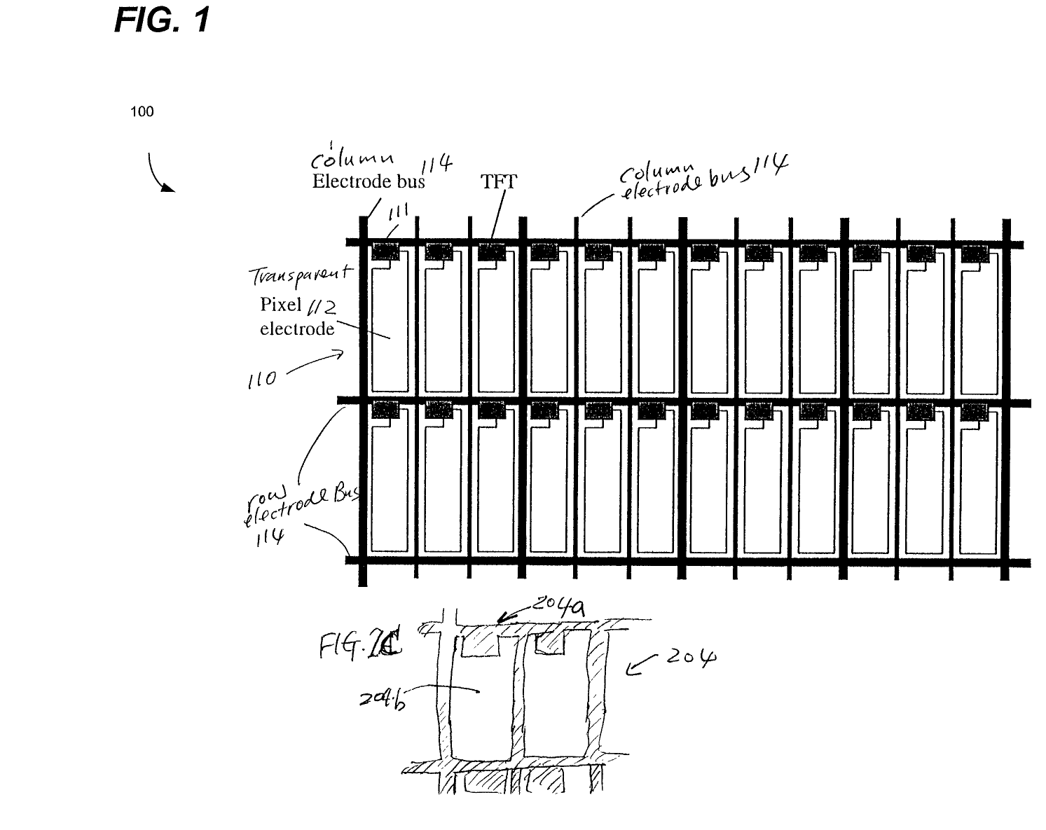

FIG. 1 shows one example of a LCD panel 100 with a two-dimensional array of LCD pixels 110. Only the circuit layer of the LCD panel 100 is illustrated. Each LCD pixel 110 includes a transparent area 112 that allows light to transmit to or from the underlying LCD layer. The transparent area 112 is usually covered by a transparent pixel electrode that supplies a pixel control voltage to the underlying LCD layer. The LCD pixel 110 also includes an opaque area through which light cannot pass. As illustrated, the opaque area may include a pixel transistor 111, such as a thin-film transistor, that is coupled to a LCD control circuit to supply the control voltage to the transparent pixel electrode. Electrode buses 114, which may include column-parallel electrode busses and row-parallel electrode busses, are also formed in the circuit layer to electrically couple the pixel transistors 111 of different LCD pixels 110 to the LCD control circuit. When formed of an opaque conducting layer, the electrode busses 114 can also add to the opaque areas in the LCD pixels connected thereto. Thus, the opaque area in each LCD pixel may include an area for placing the pixel transistor and areas occupied by portions of the electrode busses 114.

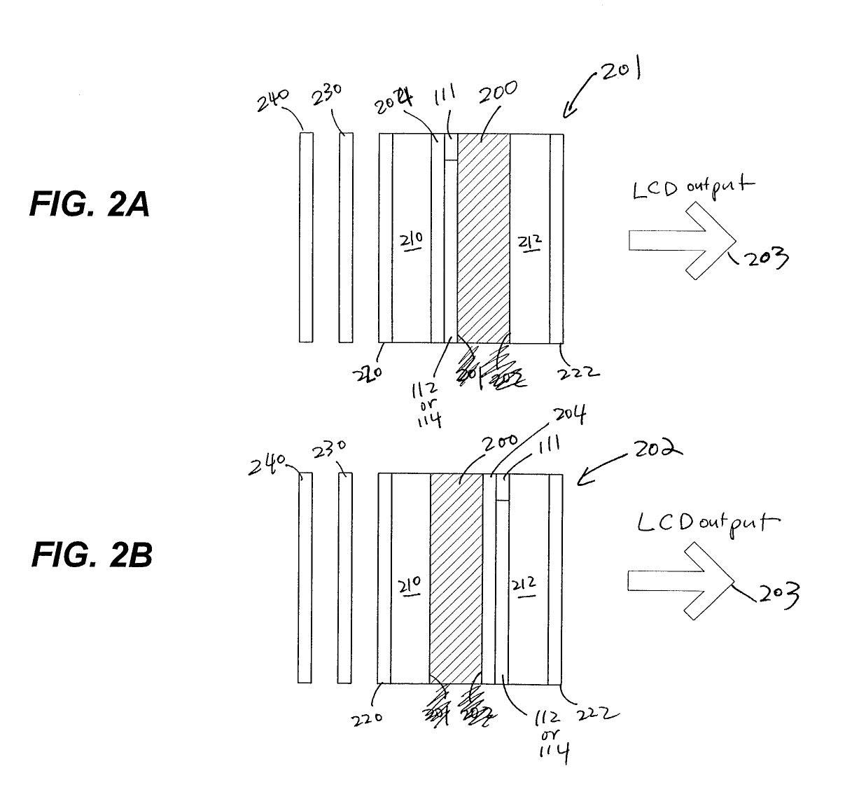

FIGS. 2A and 2B illustrate that a special reflective layer 204 can be formed over the circuit layer of the LCD panel 100 to cover only the opaque areas and to expose the transparent areas in two exemplary LCD devices. This reflective layer 204, in a combination with a reflector 240, can be used to redirect the light that hits the opaque area in each LCD pixel into a transparent area on the LCD panel.

Each LCD device includes a LCD panel (201 or 202) formed of a liquid crystal layer 200 placed between two transparent substrates 210, 212 (e.g., glass plates). The LCD circuit layer may be formed over one of the substrates 210, 212 to interface with the liquid crystal layer 200. The circuit layer may include the transparent pixel electrodes 112, the electrode busses 114 and the pixel transistors 111. Two optical polarization layers 220 and 222 are respectively a formed on the opposite exterior surfaces of the substrates 210 and 212.

The reflective layer 204 is formed over the circuit layer and is patterned according to the spatial patterns of the opaque and transparent areas in the LCD panel. FIG. 2C shows an exemplary pattern of the reflective layer 204 for the LCD panel 100. The reflective layer 204 is patterned to have reflective portions 204a that substantially cover the opaque areas such as the transistors 111 and the electrode busses 114. The reflective layer 204 may also include voids 204b shaped to expose transparent areas on the LCD panel 100, including the areas covered by the transparent pixel electrodes 112 in the LCD pixels.

A light source 230 such as a lamp is placed at one side of the LCD panel 201 or 202 to produce light that illuminates the LCD pixels. The LCD pixels, in response to the control voltages from the pixel transistors 111, modulate the input light to produce an output image 203. The reflective layer 204 is positioned to face the light source 230 so that the portion of input light incident upon the opaque areas can be reflected back towards the light source 230. The location of the reflector 240 is selected to be on the side of the light source 230 opposing the LCD panel 201 or 202 to direct the reflected light from the reflective layer 204 back to the LCD pixels. Since each light beam has a divergent angle, the propagation between the reflective layer 204 and the reflector 240 will cause the reflected beam to spread. Hence, the light that initially does not fall into the transparent areas of the LCD pixels will be reflected back and forth until it transmits into the liquid crystal layer 200.

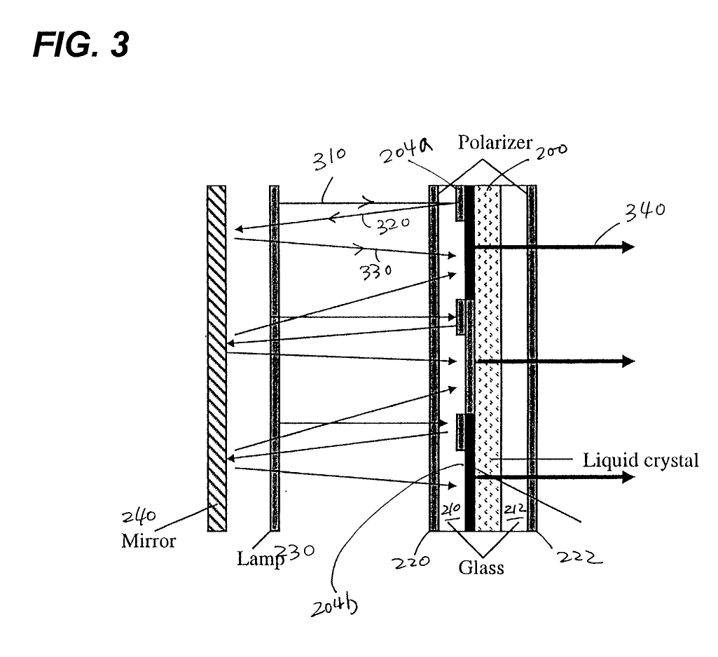

FIG. 3 further illustrates the above operation of the LCD device shown in FIG. 2A. An incident beam 310 from the light source 230 is shown to impinge upon an opaque area on the LCD panel. A reflective portion 204a on that opaque area in the reflective layer 204 reflects the incident beam 310 as a reflected beam 320 to hit the reflector 240. The beam 320 is then redirected back as a beam 330 towards the LCD panel again. At least a portion of the beam 330 is no longer directed back to the original opaque area and transmits through a transparent area 204b as a beam 340. This is in part due to the beam spread due the propagation and in part due to the direction change caused by the reflections since at least some portions of beam are not incident to the reflective portion 204a or the reflector 240 at the normal incidence. For the portions of the beam 330 that hit either the original opaque area or another opaque area, they are reflected back to the reflector 240 again. The above reflections between the reflective layer 204 and the reflector 240 continue as long as there is light that impinges upon an opaque area in the LCD panel.

Hence, without changing the physical aspect ratio between the transparent areas and the opaque areas, the above use of the reflective layer 204 and the reflector 240 can “recycle” light that hits the opaque areas to eventually hit the transparent areas in the LCD panel. Therefore, the optical efficiency, which would otherwise be limited to the aspect ratio defined by the transparent area in each pixel divided by the pixel area, can now be increased beyond the aspect ratio to nearly 100% if other optical loss can be neglected. This technique can be used to increase the display brightness without increasing the output power the light source and to reduce the power consumption of LCD devices while maintaining a desired level of image brightness. For some battery-powered devices with LCDs, this technique can be used to extend the operating time of the battery. In particular, this technique can be used to achieve a high optical efficiency in LCD systems without substantially changing many conventional LCD panel designs. Hence, the existing manufacturing processes and equipment may be used, without significant modifications, to manufacture the optically efficient LCD systems based on the designs shown in FIGS. 2A, 2B, 2C, and 3 since each LCD panel only needs an additional patterned reflective layer.

Although the present disclose only includes a few examples, it is understood that various modifications and enhancements may be made without departing from the following claims.

What is claimed is:

1. A display device, comprising:
a liquid crystal display (“LCD”) panel having a plurality of LCD pixels, each LCD pixel having a transparent area to transmit input light through a LCD layer to modulate said input light, an opaque area that does not transmit said input light through said LCD layer, and a reflective layer adapted to expose said transparent area and formed to cover said opaque area to reflect a portion of said input light incident to said opaque area; and
a reflector spaced from said LCD panel and said reflective layer to direct reflected light from said reflective layer back to said LCD pixels.

2. The device as in claim 1, comprising a light source positioned between said reflector and said LCD panel to produce said input light that illuminates said LCD panel.

3. The device as in claim 2, wherein said reflective layer is positioned between said LCD layer and said light source.

4. The device as in claim 2, wherein said LCD layer is positioned between said reflective layer and said light source.

5. The device as in claim 1, wherein said opaque area includes a transistor that supplies a control voltage to said LCD pixel.

6. The device as in claim 5, wherein said transistor is a thin-film transistor.

7. The device as in claim 1, further comprising at least one electrode bus electrically coupled to at least a portion of said LCD pixels, and wherein said opaque area in each LCD pixel of said at least a portion includes a portion of said electrode bus.

8. A display device, comprising:
a reflector;
a light source to produce light; and
a liquid crystal display (“LCD”) panel positioned to receive said light from said light source, said LCD panel having a plurality of LCD pixels, each LCD pixel having a transparent area to transmit input light through a LCD layer to modulate said light, an opaque area that does not transmit said light through said LCD layer, and a reflective layer adapted to expose said transparent area and to cover said opaque area to reflect a portion of said light incident to said opaque area to said reflector, wherein said reflector is positioned on a side of said light source opposite to a side where said LCD panel is located to direct light reflected from said reflective layer back to said LCD panel.

9. The device as in claim 8, wherein said LCD panel includes:
first and second transparent substrates to hold said liquid crystal layer therebetween, said first substrate positioned to receive said light from said light source and having a surface to support said reflective layer that is located between said first substrate and said liquid crystal layer;
a circuit layer formed on said first substrate over reflective layer to include an array of pixel transistors respectively located in said opaque areas in said LCD pixels, an array of transparent pixel electrodes respectively located in said transparent areas in said LCD pixels and respectively coupled to receive pixel control signals from corresponding pixel transistors, and a plurality of electrode buses coupled to said pixel transistors;
a first polarizer positioned between said light source and said first substrate; and
a second polarizer positioned relative to said second substrate to receive light transmitted through said liquid crystal layer.

10. The device as in claim 9, wherein said pixel transistors are thin-film transistors.

11. The device as in claim 9, wherein said reflective layer is patterned to cover at least said pixel transistors and to have voids that respectively expose said transparent pixel electrodes.

12. The device as in claim 11, wherein said reflective layer further covers said electrode busses.

13. The device as in claim 8, wherein said LCD panel includes:
first and second transparent substrates to hold said liquid crystal layer therebetween, said first substrate positioned to receive said light from said light source;
a circuit layer formed on said second substrate between said liquid crystal layer and said second substrate to include an array of pixel transistors respectively located in said opaque areas in said LCD pixels, an array of transparent pixel electrodes respectively located in said transparent areas in said LCD pixels and respectively coupled to receive pixel control signals from corresponding pixel transistors, and a plurality of electrode buses coupled to said pixel transistors, wherein said reflective layer is formed over said circuit layer between said liquid crystal layer and said circuit layer;
a first polarizer positioned between said light source and said first substrate; and
a second polarizer positioned relative to said second substrate to receive light transmitted through said liquid crystal layer.

14. The device as in claim 13, wherein said pixel transistors are thin-film transistors.

15. The device as in claim 13, wherein said reflective layer is patterned to cover at least said pixel transistors and to have voids that respectively expose said transparent pixel electrodes.

16. The device as in claim 15, wherein said reflective layer further covers said electrode busses.

17. A method, comprising:
projecting light from a light source to illuminate a liquid crystal display (LCD) panel of an array of LCD pixels;
using a liquid crystal layer in each LCD pixel to modulate light incident to a transparent area in the LCD pixel;
using a reflective coating on an opaque area from each LCD pixel to reflect light incident thereto back towards the light source; and
directing light reflected from the opaque area back towards the LCD panel to cause at least a portion of the reflected light to hit a transparent area on the LCD panel.

18. The method as in claim 17, wherein a reflector is used to direct the reflected light to the LCD panel and the light source is located between the reflector and the LCD panel.

19. The method as in claim 17, wherein the LCD panel includes an array of thin-film transistors respectively located in said LCD pixels, and the reflective coating is shaped to cover each of said thin-film transistors that is positioned over the liquid crystal layer.

20. The method as in claim 19, wherein the LCD panel includes a plurality of conductor busses to provide electrical connections to said thin-film transistors, and the reflective coating is further shaped to cover each portion of said conductor busses that is positioned over the liquid crystal layer.
